(19) United States
(12) Patent Application Publication
(10) Pub. No.: US 2004/0232833 A1
(43) Pub. Date: Nov. 25, 2004

(54) Organic electroluminescent panel and method for fabricating the same

(75) Inventors: Michio Menda, Yamagata-ken (JP); Masami Kimura, Yamagata-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Tohoku Pioneer Corporation

(21) Appl. No.: 10/844,312

(22) Filed: May 13, 2004

(30) Foreign Application Priority Data
May 22, 2003 (JP) 2003-144674
Nov. 21, 2003 (JP) 2003-392476

(51) Int. Cl. H05B 33/04; H05B 33/10

(52) U.S. Cl. 313/512; 313/511; 313/504; 313/506; 445/25

(57) ABSTRACT

An organic EL panel has a support substrate on which an organic EL device layer is formed. The support substrate is adhered to a sealing substrate via an adhesive to define a sealed space for encapsulating the organic EL device between both the substrates. The sealing substrate is made of a transparent material. On the inner surface of the sealing substrate, a color filter layer is formed. This structure allows light emitted from the organic EL device to transmit through the sealing substrate after having passed through the color filter layer. A transparent moisture capturing film is formed on the inner surface of the sealing substrate to cover the color filter layer, thereby filling the sealed space with transparent moisture capturing film. Thereby, the organic EL panel is provided, which makes it possible to obtain a sufficient moisture capturing effect in the sealed space.

### BACKGROUND OF THE INVENTION

The present invention relates to an organic electroluminescent panel and a method for fabricating the same.

The present application claims priority from Japanese Patent Application Nos. 2003-144674 and 2003-392476, the disclosures of which are incorporated herein by reference.

An organic electroluminescent panel (hereinafter referred to as organic EL panel) has an organic electroluminescent device (hereinafter referred to as organic EL device) that is formed on a support substrate by sandwiching an organic layer stack including an emission functioning layer between a pair of electrodes. One or more organic EL devices are arranged as a surface emission element to form a display region. Since the organic layer stack and the electrodes exposed to the atmosphere would cause deterioration in the emission property of the organic EL device, the organic EL panel is inevitably provided with a sealing member for isolating the organic EL device from the atmosphere.

On the other hand, the organic EL panel is provided with at least one transparent electrode, such as of ITO (Indium Tin Oxide), of the aforementioned pair of electrodes, so that light generated in the emission layer or the like is transmitted through the transparent electrode. Thus, the organic EL panel employs two types of emission: the bottom emission type which allows light to transmit through a transparent support substrate with the bottom electrodes being made transparent on the support substrate; and the top emission type which allows light to transmit through the top electrodes with the top electrodes opposite to the bottom electrodes being made transparent.

FIG. 1 illustrates a prior art organic EL panel disclosed in Japanese Patent Application Laid-Open No. 2001-126862 (FIG. 1 and Paragraph 0005), which has a top-emission color display capability. This organic EL panel has an organic EL device formed of a cathode 4A, an emission layer 5, and a transparent anode 4B on a glass substrate 1. The glass substrate 1 is adhered to a sealing cap 2 via a sealing member 2A using an adhesive 3 to define a sealed space, thereby encapsulating the organic EL device therein. On the inner surface of the sealing cap 2, formed are color filters 6, around each of which formed is an overcoat film 7. There is also arranged a moisture capturing agent 8 except for the faces opposite to the color filters 6 (i.e., between respective color filters and at both ends of the panel).

Such a prior art organic EL panel is provided with an overcoat film to prevent moisture or gas from being released from the color filters and a black matrix disposed between the respective color filters into the sealed space. However, moisture, oxygen or the like which may cause deterioration in the organic EL device may come into the sealed space from outside. Deterioration may also be caused upon driving the organic EL device or by the moisture or the like present in the sealed space at the initial stage of the sealing step. To prevent the deterioration, a moisture capturing agent must be additionally provided.

However, to effectively ensure the emission surface area ratio of the organic EL device, the moisture capturing agent is disposed only at limited portions in the sealed space, thereby raising a problem that a sufficient moisture capturing effect cannot be obtained. Furthermore, no moisture capturing agent can be provided on the emission region of the organic EL device, thereby raising another problem that efficient countermeasures cannot be taken against deterioration in the organic EL device.

Still furthermore, on the sealing cap side, it is necessary to go through a complicated fabrication process of forming the color filters on the inner surface of the sealing cap, forming the overcoat film thereon, and then forming the moisture capturing agent layer having an opening pattern. Additionally, since the opening pattern of the moisture capturing agent layer must agree with the emission region of the organic EL device, highly accurate positioning is required upon adhering the sealing cap to the support substrate on the organic EL device side. This also raises the problems of making the fabrication process complicated and the yield of the resulting products easily reduced.

### SUMMARY OF THE INVENTION

It is therefore an object of the present invention to address these problems. That is, an object of the present invention is to provide an organic EL panel, as mentioned below, having a top emission color display capability and a method for fabricating the same. The panel and the method make it possible to provide a sufficient moisture capturing effect within a sealed space, to take an efficient countermeasure against deterioration in the organic EL device, to simplify the fabrication process, and to improve the yield of the resulting products, thereby reducing the fabrication costs.

To achieve the aforementioned objects, the organic EL panel and the method for fabricating the panel according to the present invention include at least the features set forth in each of the following independent claims.

According to one aspect of the present invention, an organic EL panel comprises an organic EL device formed by sandwiching an organic layer stack including an organic luminescent layer between a pair of electrodes on a support substrate, the organic EL device being encapsulated in a space defined by adhering a transparent sealing substrate to the support substrate, wherein a color filter layer is formed on an inner surface of the sealing substrate, the color filter layer is covered with an optically transparent moisture capturing film, and the support substrate and the sealing substrate are adhered to each other so as to fill a sealed space between the color film layer and the organic EL device with the moisture capturing film, thereby allowing light to transmit through the sealing substrate.

According to another aspect of the present invention, a method for fabricating an organic EL panel comprises the steps of: forming an organic EL device by sandwiching an organic layer stack including an organic luminescent layer between a pair of electrodes on a support substrate; forming a color filter layer on a surface of a transparent sealing substrate as well as forming an optically transparent moisture capturing film for covering the color filter layer; and adhering the support substrate and the sealing substrate to each other, with the color filter layer contained therein, to fill a sealed space between the color film layer and the organic EL device with the moisture capturing film, thereby encapsulating the organic EL device therein, wherein light is allowed to transmit through the sealing substrate.

### BRIEF DESCRIPTION OF THE DRAWINGS

These and other objects and advantages of the present invention will become clear from the following description with reference to the accompanying drawings, wherein:

FIG. 1 is an explanatory view illustrating the prior art;

FIG. 2 is an explanatory view illustrating an organic EL panel according to an embodiment of the present invention;

FIG. 3 is an explanatory view illustrating an organic EL panel according to another embodiment of the present invention;

FIG. 4 is an explanatory view illustrating a specific example of an organic EL device layer in an organic EL panel according to an embodiment of the present invention; and

FIGS. 5A and 5B are explanatory views illustrating a method for fabricating an organic EL panel according to an embodiment of the present invention.

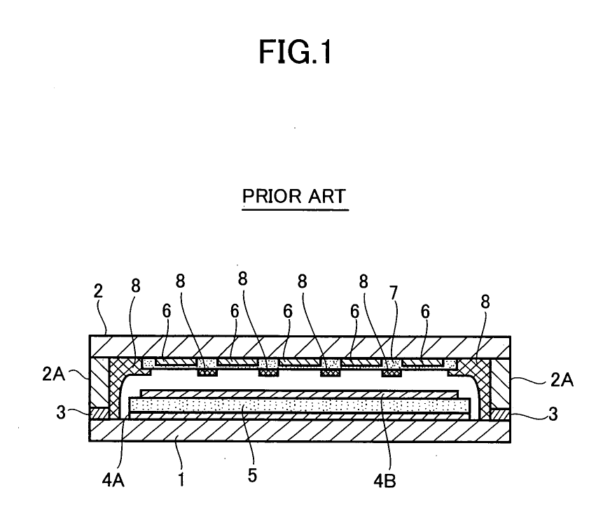

### DETAILED DESCRIPTION OF THE PREFERRED EMBODIMENTS

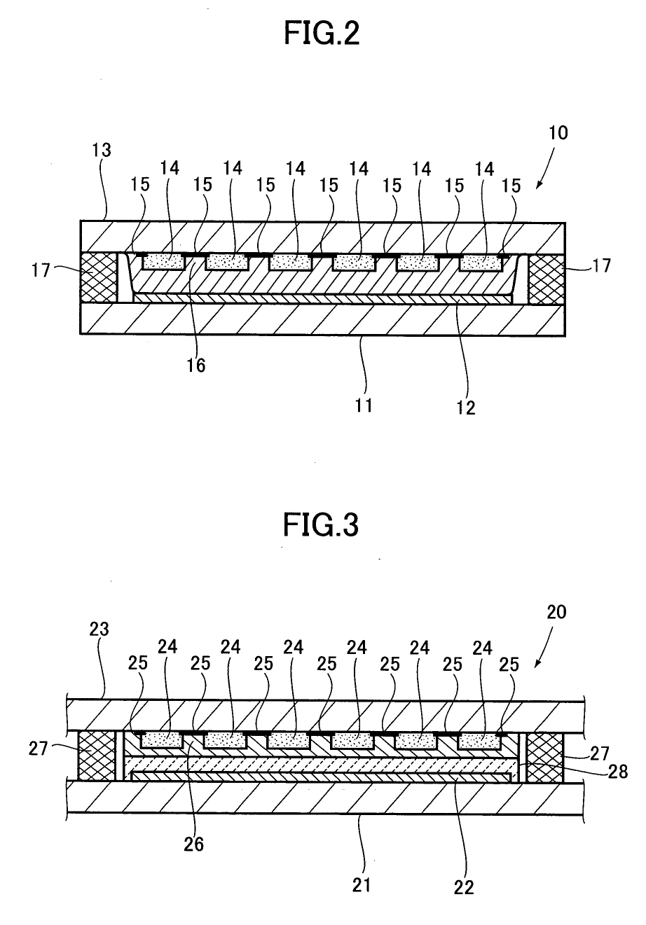

Now, the present invention will be described below in more detail with reference to the accompanying drawings in accordance with the embodiments. FIG. 2 is an explanatory view illustrating an organic EL panel according to an embodiment of the present invention. An organic EL panel 10 has an organic EL device layer 12 constituting an organic EL device that has an organic layer stack including an organic luminescent layer. The organic layer stack is sandwiched between a pair of electrodes on a support substrate 11. The support substrate 11 is adhered to a sealing substrate 13 via an adhesive 17, thereby defining a sealed space for encapsulating the organic EL device in between both the substrates.

The sealing substrate 13 is made of a transparent material. On the inner surface of the sealing substrate 13, formed are a black matrix 15 as required which has an opening corresponding to the emission region of the organic EL device and a color filter layer 14 to oppose the emission region of the organic EL device. This structure provides a top emission color display panel in which light emitted from the organic EL device is transmitted through the sealing substrate 13 after having passed through the color filter layer 14.

The embodiment of the present invention allows an optically transparent moisture capturing film (hereinafter referred to as moisture capturing film) 16 to be formed on the inner surface of the sealing substrate 13 so as to cover the color filter layer 14. Additionally, the transparent moisture capturing film 16 is brought into contact with the organic EL device layer 12, thereby allowing the sealed space between the support substrate 11 and the sealing substrate 13 to be filled with the transparent moisture capturing film 16. This allows the transparent moisture capturing film 16 to cover the entirety of the color filter layer 14, thereby being formed on the organic EL device layer 12 opposite to the emission region of the organic EL device.

First, the organic EL panel 10 configured in this manner is provided with the transparent moisture capturing film 16 to cover the color filter layer 14 and the black matrix 15. This allows moisture and gas emitted from the color filter layer 14 and the black matrix 15 into the sealed space to be blocked with the transparent moisture capturing film 16, thereby preventing deterioration in the organic EL device caused by the color filter layer 14 or the black matrix 15 from occurring within the sealed space. Secondly, the transparent moisture capturing film 16 is provided generally across the entire sealed space. The transparent moisture capturing film 16 thus formed can provide a sufficient amount of moisture capturing agent to absorb moisture coming from outside into the sealed space and moisture or the like present at the initial stage of the sealing step. Furthermore, the transparent moisture capturing film 16 can be provided opposite to the emission region of the organic EL device. This configuration can effectively prevent deterioration in the organic EL device. Additionally, the transparent moisture capturing film 16 covers the color filter layer 14, thereby exerting no effect on the opening ratio of the color filter layer 14. Thus, it is possible to form a top emission color display panel which allows the organic EL device to transmit light with high efficiency.

The sealed space is filled with the transparent moisture capturing film 16 by bringing the film 16 into contact with the organic EL device layer 12. This allows the spacing between the support substrate 11 and the sealing substrate 13 to remain constant even when the panel is curved. The sealed space is filled with the transparent moisture capturing film 16 as described above. This also allows the emission path from the emission surface of the organic EL device to the color filter layer 14 to be occupied with a medium having a single refractive index, thereby providing good color display exhibiting no color shift caused by a variation in refractive index.

FIG. 3 is an explanatory view illustrating an organic EL panel according to another embodiment of the present invention. An organic EL panel 20 has an organic EL device layer 22 formed in the same manner as in the aforementioned embodiment. The organic EL device layer 22 is formed on a support substrate 21, the latter of which is adhered to a sealing substrate 23 via an adhesive 27 to define a sealed space for encapsulating the organic EL device in between both the substrates. In the aforementioned structure, the support substrate 21 and the sealing substrate 23 are made of a flexible material such as plastic film, thereby making the entirety of the organic EL panel 20 flexible.

The sealing substrate 23 is also made of a transparent material. On the inner surface of the sealing substrate 23, a black matrix 25 similar to the one mentioned above is formed as required, and a color filter layer 24 is formed which is similar to the one mentioned above. This structure provides a top emission color display panel in which light emitted from the organic EL device passes through the color filter layer 24 to transmit through the sealing substrate 23.

Additionally, in this embodiment, a transparent moisture capturing film 26 is formed on the inner surface of the sealing substrate 23 to cover the color filter layer 24. Moreover, upon adhering the support substrate 21 to the sealing substrate 23, a buffer layer 28 of a transparent organic polymer or organic metal complex is provided on the organic EL device layer 22 to fill in the sealed space. As used herein, the buffer layer 28 presents no problem as long as it is made of a transparent material, and thus can be made of an optically or thermally hardened resin such as UV cure epoxy resin as well as a two-part cure acrylic resin, an elastic material such as rubber, a plastic material, or an inorganic material.

This embodiment can provide the same effects as those of the aforementioned embodiment as well as flexibility to the organic EL panel 20 for extended use of the panel. Additionally, the sealed space defined between the support substrate 21 and the sealing substrate 23 is filled with the transparent moisture capturing film 26 and the transparent buffer layer 28. This allows of completely blocking any factors causing deterioration in the organic EL device from the organic EL device layer 22. This also prevents direct contact of the organic EL device layer 22 with the transparent moisture capturing film 26 even when the panel is curved and allows the spacing between the substrates to remain unchanged. Furthermore, the refractive indices of the transparent moisture capturing film 26 and the buffer layer 28 can be adjusted to be equal to each other, thereby providing good color display without any color shift.

More specifically, the transparent moisture capturing film 16, 26 employed in each of the aforementioned embodiments can be made of a moisture capturing agent dissolved in a solvent or dispersed in a transparent resin or the like. Preferably, the transparent moisture capturing film 16, 26 is heated before adhesion so that moisture or the like near the surface thereof is removed beforehand. On the other hand, the optical transparency of the transparent moisture capturing film 16, 26 can be made 10 to 99%, preferably 50% or more, thereby ensuring a good display performance.

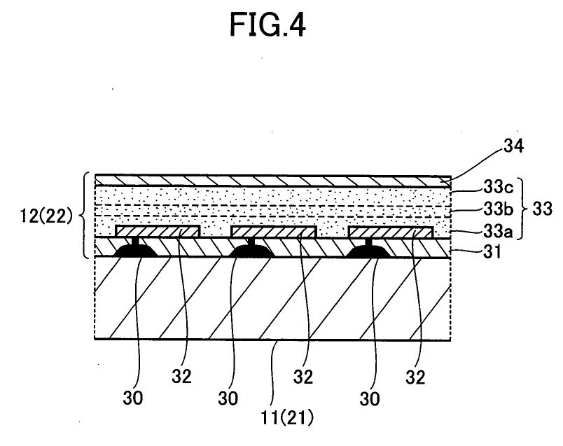

FIG. 4 is an explanatory view illustrating a structural example of the organic EL device layer 12, 22 of each of the aforementioned embodiments. Now, an active drive example will be shown which has a thin-film drive device 30 formed on the support substrates 11, 21; however, the embodiments of the present invention are not limited thereto. First, on the support substrates 11, 21, the thin-film drive device 30 such as TFT (Thin Film Transistor) for driving the organic EL device is provided at each unit emission region, with a flattened insulating film 31 formed on the thin-film drive device 30. On the flattened insulating film 31, a bottom electrode 32 of the organic EL device is sectioned for each unit emission region. On the bottom electrode 32, formed is an organic layer stack 33 which includes organic luminescent layers such as a hole transport layer 33a, an emission layer 33b, and an electron transport layer 33c. On top thereof, formed is a top electrode 34 of the organic EL device as a uniform electrode layer. Here, by way of example, to transmit light emitted from the organic EL device through the top electrode 34, the bottom electrode 32 is made of a metal as an anode and the top electrode 34 is made of a transparent material as a cathode to form each layer of the aforementioned organic layer stack 33 therebetween.

The organic EL device according to this embodiment is not limited to such an active matrix drive device but may also be a passive matrix drive device having stripe electrodes disposed in an orthogonal relation to each other to form the top electrodes and the bottom electrodes. However, the organic EL device employs the top emission scheme for transmitting light through the top electrode. Thus, the active matrix device having the thin-film drive device 30 such as TFT formed under the organic EL device (below the bottom electrode) can better arrange the drive devices irrespective of the opening ratio, thus advantageously providing an improved design flexibility to the drive device.

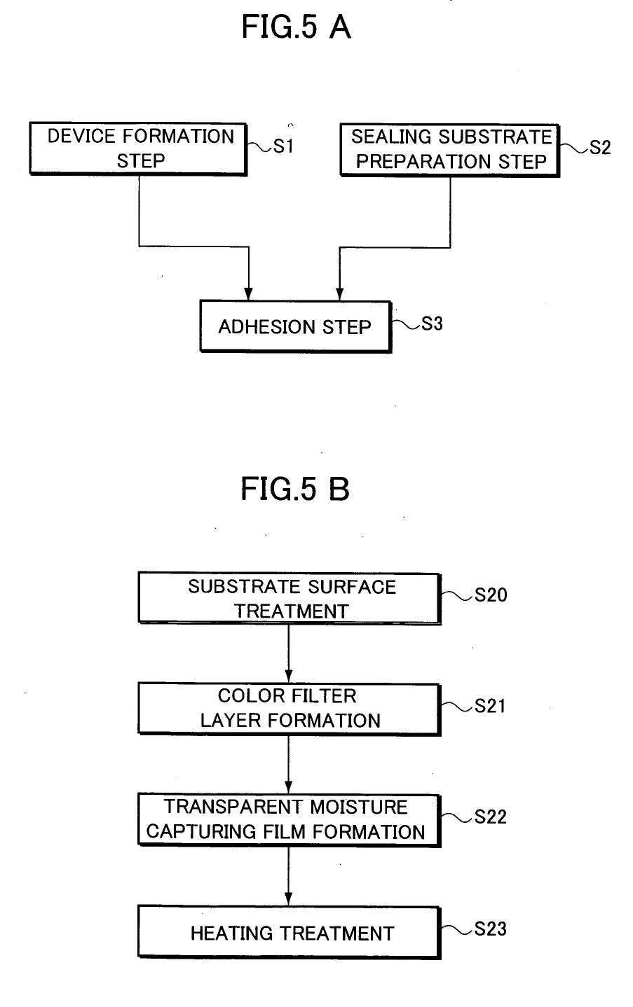

FIGS. 5A and 5B are explanatory views illustrating the method for fabricating an organic EL panel according to an embodiment of the present invention. FIG. 5A is a schematic flow showing the fabrication method, and FIG. 5B is a flow showing each stage of the sealing substrate preparation step. Referring to FIG. 5A, in a device formation step S1, on the support substrate 11 (21) formed first is the organic EL device layer 12 (22) made up of an organic layer stack including organic luminescent layers that are sandwiched between a pair of electrodes. In this step, the deposition and patterning processes known to those skilled in the art are employed which are generally used to form the organic EL device.

On the other hand, in a sealing substrate preparation step S2, each step shown in FIG. 5B is performed. Then, in an adhesion step S3, the adhesive 17 (27) is applied around one or both of the support substrate 11 (21) and the sealing substrate 13 (23) to adhere the support substrate 11 (21) to the sealing substrate 13 (23), thereby encapsulating the organic EL device layer 12 (22) between both the substrates. Thereafter, an appropriate inspection step is performed as required to obtain the organic EL panel 10 (20) according to the embodiments.

In the sealing substrate preparation step S2, the surfaces of the support substrate 11 (21) are treated by washing (S20). Thereafter, the color filter layer 14 (24) including the black matrix 15 (25) is deposited and patterned on one surface of the support substrate 11 (21) (S21). The transparent moisture capturing film 16 (26) is then applied to the color filter layer 14 (24) by coating to form the film (S22). Then, as described above, the transparent moisture capturing film 16 (26) is heated, and the process proceeds to the subsequent adhesion step.

According to such a method for fabricating the organic EL panel, a moisture capturing agent can be well prepared only in the step of forming the transparent moisture capturing film 16 (26). Thus, the single transparent moisture capturing film 16 (26) provides the functions of the prior art overcoat film and moisture capturing film described above, thereby providing a simplified step. Furthermore, the transparent moisture capturing film 16 (26) can be deposited in a simple manner, so that no such patterning is required as for the prior art moisture capturing film. Accordingly, the deposition step can be significantly simplified, and highly accurate positioning is not required in the adhesion step. This makes it possible to improve the yield and thereby reduce manufacturing costs.

Furthermore, in the adhesion step, the sealed space above the organic EL device layer 12 (22) is filled with the transparent moisture capturing film 16 (26) and/or the buffer layer 28. This provides a uniform refractive index to the emission path from the emission surface to the color filter layer 14 (24) (the refractive indices of the transparent moisture capturing film 26 and the buffer layer 28 are made equal to each other when the buffer layer 28 is provided). This also provides good color display without color shifts. The sealed space is filled in this adhesion step as described above and therefore made less vulnerable to the entry of air bubbles when compared with a case of separately injecting a filler into the space, thereby allowing the panel to be fabricated with high accuracy.

### EXAMPLE

Now, implementations of the present invention are described below in accordance with specific examples of the structural material for each part of the organic EL panel shown in the embodiments.

a. Color Filter: The color filter as used herein is a general name given to filters that allow light emitted from the organic EL device to transmit therethrough to provide a particular color. The filters include the so-called color filter which selects a particular wavelength of the wavelengths emitted from the organic EL device, and the color conversion filter which converts the wavelength of light emitted from the organic EL device. The color filter may have a single layer of color filter of a particular type or a layered stack of color filters of different types. For example, such a structure can be employed which has a layered stack of color filters each corresponding to R, G, B or the like in the color conversion layer. This structure would eliminate such a problem of fluorescent light caused by the color conversion layer being excited by ambient light, the problem being conceivably also responsible for a decrease in display contrast.

The type of colors of a color filter is not limited to any particular one so long as it has two or more colors. Three primary colors R, G, and B can be employed for display in full color; however, two or four colors may also be employed for display in multi colors. Additionally, the display area, shape, and arrangement or the like of each unit region for a plurality of colors are not limited to particular ones but may also be designed in a different way as appropriate.

b. Transparent Moisture Capturing Film: This film is deposited by coating using the following materials. The materials can be obtained by dissolving transparent physical drying agents (such as zeolite, silica gel, carbon, or carbon nanotubes), chemical drying agents (such as alkali metal oxide, metal halide, or chlorine peroxide), or particular organic metal complexes having the moisture capturing capability in a petroleum based solvent (such as a toluene, xylene, or aliphatic organic solvent). The materials can also be obtained by suspending drying agent particles in a transparent resin binder (such as of polyethylene, polyisoprene, or polyvinyl cinnamate). The transparency of the transparent moisture capturing film is set at 10 to 99%, or preferably at 50% or more.

c. Electrodes: The top and bottom electrodes may be set for either the cathode or the anode (but the anode is made of a material having a higher work function than that of the cathode); however, as an example of the present invention, it is necessary to select an electrode material that can serve for the top emission scheme with a transparent electrode employed as the top electrode. By way of example, the top electrode can be a transparent electrode made of a metal oxide film such as ITO or IZO, while the bottom electrode can be made of metal film such as aluminum (Al) or magnesium (Mg), an amorphous semiconductor such as doped poly-aniline or doped polyphenylene vinylene, or an oxide such as Cr₂O₃, NiO, or Mn₂O₅. When both the top and bottom electrodes are made of a transparent material, a reflective film is provided to the bottom electrode side.

d. Organic Layer stack (Organic Luminescent Layers): In general, the organic layer stack has a combination of the hole transport layer, the emission layer, and the electron transport layer, as in the aforementioned embodiment (see FIG. 4). However, the emission layer, the hole transport layer, and the electron transport layer may be prepared each in a single layer or in a plurality of layers. One or both of the hole transport layer and the electron transport layer may be eliminated. On the other hand, it is also possible to provide an organic layer stack including a hole injection layer or an electron injection layer, as required. The aforementioned hole transport layer, emission layer, and electron transport layer can be made of a conventional material selected as appropriate.

e. Adhesive; As the adhesive, it is possible to use a thermosetting type, chemically hardened (two-part mixture) type, or photo (ultraviolet) cure type adhesive, which includes acrylic resin, epoxy resin, polyester, and polyolefin. In particular, the adhesive is preferably an ultraviolet cure epoxy resin. Such an adhesive is mixed with an appropriate amount (about 0.1 to 0.5% by weight) of spacers (preferably made of glass or plastic) having a particle diameter of 1 to 300 μm. The resulting mixture is applied around the support substrate or the sealing substrate using a dispenser or the like.

The present invention is realized as described above in accordance with the embodiments and examples. Thus, in the organic EL panel for providing color display according to the top emission scheme, it is possible to obtain a sufficient moisture capturing effect in a sealed space, to take efficient countermeasures against deterioration in the organic EL device, to simplify the fabrication process, and to improve the yield of the resulting products to reduce the costs. It is also possible to provide good color display without color shifts.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An organic EL panel, comprising:
a support substrate;
an organic EL device formed by sandwiching an organic layer stack including an organic luminescent layer between a pair of electrodes on the support substrate;
a transparent sealing substrate for encapsulating the organic EL device in a space defined by adhering the transparent sealing substrate to the support substrate;
a color filter layer formed on an inner surface of the sealing substrate; and
an optically transparent moisture capturing film for covering the color filter layer,
wherein the support substrate and the sealing substrate are adhered to each other so as to fill a sealed space between the color filter layer and the organic EL device with the moisture capturing film, allowing light to transmit through the sealing substrate.

2. The organic EL panel according to claim 1, further comprising:
a buffer layer interposed between the moisture capturing film and the organic EL device to fill the sealed space.

3. The organic EL panel according to claim 1, wherein
the sealed space is filled by bringing the moisture capturing film into contact with the organic EL device.

4. The organic EL panel according to claim 1, wherein
the moisture capturing film is formed by dissolving a moisture capturing agent in a solvent.

5. The organic EL panel according to claim 1, wherein
the moisture capturing film is formed by dispersing a moisture capturing agent in a transparent resin.

6. The organic EL panel according to claim 1, wherein
the moisture capturing film is a film to be heated.

7. The organic EL panel according to claim 1, wherein
the organic EL device is driven by a thin-film drive device formed on the support substrate.

8. A method for fabricating an organic EL panel comprising the steps of:
forming an organic EL device by sandwiching an organic layer stack including an organic luminescent layer between a pair of electrodes on a support substrate;
forming a color filter layer on a surface of a transparent sealing substrate and forming an optically transparent moisture capturing film for covering the color filter layer; and
adhering the support substrate and the sealing substrate to each other, with the color filter layer contained therein, to fill a sealed space between the color filter layer and the organic EL device with the moisture capturing film, thereby encapsulating the organic EL device therein,
wherein light is allowed to transmit through the sealing substrate.

9. The method for fabricating an organic EL panel according to claim 8, wherein
a buffer layer is interposed between the moisture capturing film and the organic EL device to fill the sealed space.

10. The method for fabricating an organic EL panel according to claim 8, wherein
the sealed space is filled by bringing the moisture capturing film into contact with the organic EL device.

11. The method for fabricating an organic EL panel according to claim 8, wherein
the moisture capturing film is formed by dissolving a moisture capturing agent in a solvent.

12. The method for fabricating an organic EL panel according to claim 8, wherein
the moisture capturing film is formed by dispersing a moisture capturing agent in a transparent resin.

13. The method for fabricating an organic EL panel according to claim 8, wherein
the moisture capturing film is subjected to heat treatment before the step of adhering.

14. The method for fabricating an organic EL panel according to claim 8, wherein
the organic EL device is driven by a thin-film drive device formed on the support substrate.
